(19) United States
(12) Patent Application Publication
(10) Pub. No.: US 2023/0148728 A1
(43) Pub. Date: May 18, 2023

(54) HAIR REMOVER

(71) Applicant: Shenzhen Yumi Info. Co., Ltd, Shenzhen (CN)

(72) Inventor: Xuelian ZHANG, Shenzhen (CN)

(21) Appl. No.: 17/568,737

(22) Filed: Jan. 5, 2022

(30) Foreign Application Priority Data
Nov. 12, 2021 (CN) 202111341100.7

(51) Int. Cl. A45D 26/00

(52) U.S. Cl. CPC A45D 26/0038

(57) ABSTRACT

A hair remover is provided, including a main body, a positioning member, a mounting member and a blade assembly. The positioning member is mounted on the main body. The mounting member has one end connected to the blade assembly and one other end received in the positioning member and movably connected thereto. The mounting member defines a receiving chamber. At least one through hole communicating with the receiving chamber is defined on a periphery of the mounting member. The mounting member is slidable to enable the positioning member to completely cover the through hole.

### CROSS-REFERENCE TO RELATED APPLICATIONS

The present disclosure claims priority to Chinese Patent Application No. 202111341100.7, filed Nov. 12, 2021, which is hereby incorporated by reference herein as if set forth in its entirety.

### TECHNICAL FIELD

The present disclosure relates to relates to the technical field of personal care products, in particular to a hair remover.

### BACKGROUND

Electronic hair remover is a common personal care product, which is used by consumers to remove body hair. The electric hair remover is provided under a blade with a receiving groove for collecting body hair scraps. It is necessary to disassembly or open the blade assembly of the electric hair remover for cleaning of the receiving groove, which is troublesome.

In order to solve the above problem, for example, Chinese patent No. 201010290604.6 provides a nose hair trimmer provided with a structure with which an internal chamber X can be cleaned without disassembling or opening the blade unit 12. Specifically, a main body 11 is provided with an outlet 15e communicating with the internal chamber X, and a movable cover 19 configured to cover the outlet 15e or uncover the outlet 15e. As disclosed in FIGS. 5(a) and 5(b) in the aforementioned document, two cleaning modes are provided as follows.

A first mode is that water enters the internal chamber X through the blade unit 12 and finally exits the main body 11 from the outlet 15e, thereby rushing the nose hair scraps away from the internal chamber X.

A second mode is that the blade unit 12 rotates to draw the water into the internal chamber X and finally discharge the water out of the main body 11 from the outlet 15e, thereby rushing the nose hair scraps away from the internal chamber X.

The cleaning structure of the above nose hair trimmer has the following defects.

Firstly, only one outlet 15e is provided, with merely one flow path for the water. Especially in the first mode, there is some dead corners of cleaning as it is difficult for the water to fill the entire internal chamber X, so that the nose hair scraps can not be completely rushed away from the internal chamber X.

Secondly, since the outlet 15e is located at a bottom of the internal chamber X, and it is difficult for the user to see clearly the entire internal chamber X through the outlet 15e to determine whether the nose hair scraps is completely rushed away from the internal chamber X.

### SUMMARY

In order to solve the above problems, the present disclosure provides a hair remover which is convenient in cleaning.

The present disclosure is realized by the following technical schemes.

The present disclosure provides a hair remover including a main body, a positioning member, a mounting member and a blade assembly. The positioning member is mounted on the main body. The mounting member has one end connected to the blade assembly and one other end received in the positioning member and movably connected thereto. The mounting member defines a receiving chamber. At least one through hole communicating with the receiving chamber is defined on a periphery of the mounting member. The mounting member is slidable to enable the positioning member to completely cover the through hole.

In an embodiment, a tapered boss protrudes from a bottom of the receiving chamber.

In an embodiment, the receiving chamber is further provided with a stopper ring fixedly connected to the mounting member. The main body is provided with a motor with a drive shaft. The drive shaft sequentially passes through the tapered boss and the stopper ring to connect with the blade assembly in a transmission manner.

In an embodiment, the blade assembly includes a cutter and a cover. The cutter is movably received in the cover and abuts against the stop ring. One end of the drive shaft away from the motor is engaged with the cutter.

In an embodiment, a snap is provided in the cover, a groove is provided on the periphery of the mounting member, and the snap is engaged with the groove.

In an embodiment, a first sliding slot is provided on the periphery of the mounting member and extends vertically. Both ends of the first sliding slot are recessed inwardly to form a first limiting hole and a second limiting hole. The positioning member is provided with a first sliding block movably received in the first sliding slot. The first sliding block is slidable to engage with the first limiting hole or the second limiting hole.

In an embodiment, a third limiting hole is defined on the periphery of the mounting member and communicates with the first limiting hole. A first limiting plate is provided at a connection between the third limiting hole and the first limiting hole. The first sliding block is slidable to engage with the third limiting hole.

In an embodiment, a second sliding slot and a third sliding slot are defined on the periphery of the mounting member. The second sliding slot extends horizontally. The third sliding slot extends to form a notch at an end of the mounting member. The third sliding slot communicates with the second sliding slot, and the second sliding slot communicates with the second limiting hole. A second limiting plate is provided at a connection between the second sliding slot and the second limiting hole.

In an embodiment, a fourth sliding slot is defined on a periphery of the main body and extends horizontally. A second sliding block is provided in the positioning member and movably received in the fourth sliding slot. At least one fourth limiting hole is formed in the fourth sliding slot. The second sliding block slidable to engage with each of the at least one fourth limiting hole.

In an embodiment, a fifth sliding slot is defined on the periphery of the main body and communicates with the fourth sliding slot, and the fifth sliding slot extends to form a notch at an end of the main body.

The present disclosure has the following advantageous effects.

Three through holes are provided on the periphery of the mounting member of the hair remover according to the present disclosure. During cleaning, the blade assembly is slid to expose the through holes completely, and the receiving chamber can be washed with water in any direction to ensure that the body hair scraps are completely removed from the receiving chamber, and the entire receiving chamber can be seen by the user through the through holes.

### BRIEF DESCRIPTION OF THE DRAWINGS

In order to illustrate the technical solutions according to the embodiments of the present disclosure more clearly, the accompanying drawings for describing the embodiments are introduced briefly in the following. Apparently, the accompanying drawings in the following description are merely some embodiments of the present disclosure, and those skilled in the art may derive other drawings from the accompanying drawings without creative efforts.

FIG. 1. is a perspective view of a hair remover according to an embodiment of the present disclosure, with a through hole fully exposed.

FIG. 2 is an explosive view of a hair remover according to an embodiment of the present disclosure.

FIG. 3 is a perspective view of a positioning member of a hair remover according to an embodiment of the present disclosure.

FIG. 4 is a perspective view of a mounting member of a hair remover according to an embodiment of the present disclosure.

FIG. 5 is another perspective view of the mounting member of the hair remover according to an embodiment of the present disclosure.

FIG. 6 is a perspective view of a blade assembly of a hair remover according to an embodiment of the present disclosure.

FIG. 7 is a partial perspective view of a hair remover according to an embodiment of the present disclosure.

### DETAILED DESCRIPTION

For clearer and complete description to the technical schemes of the present disclosure, the present disclosure is described further with reference to the accompanying drawings.

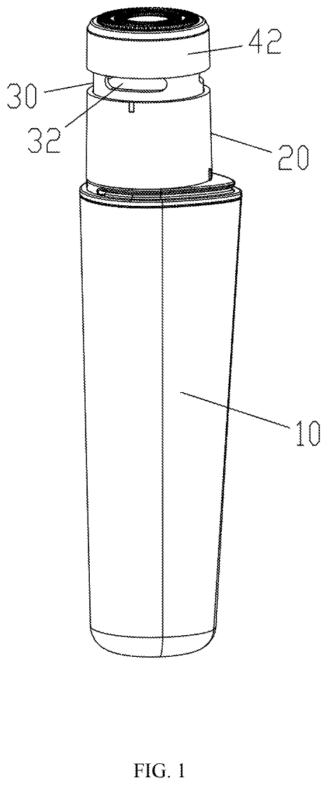

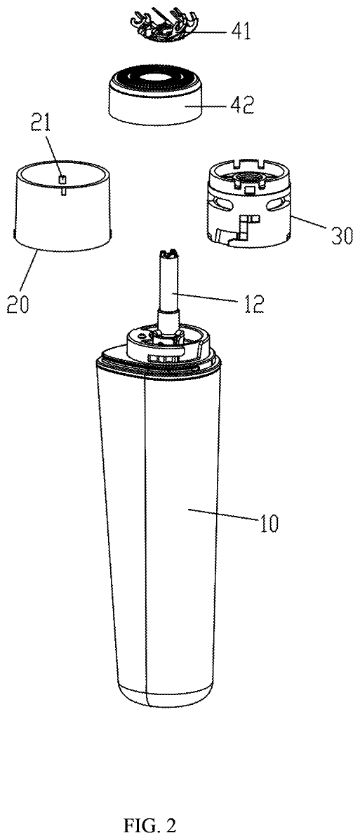

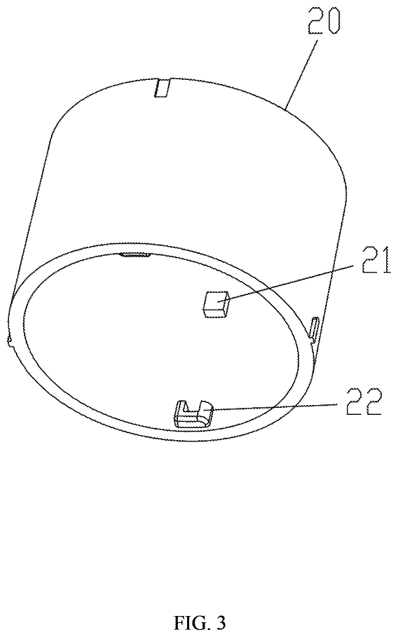

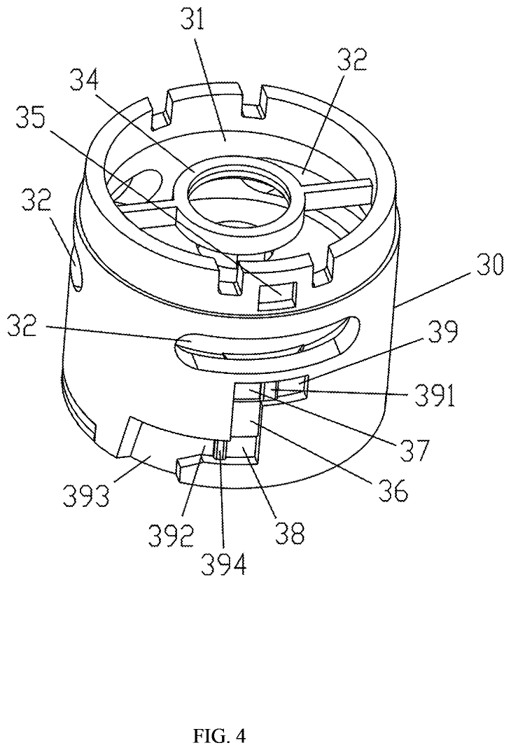

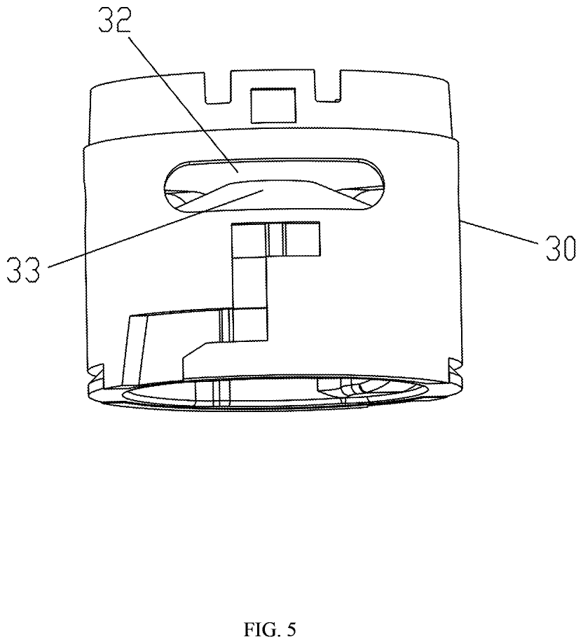

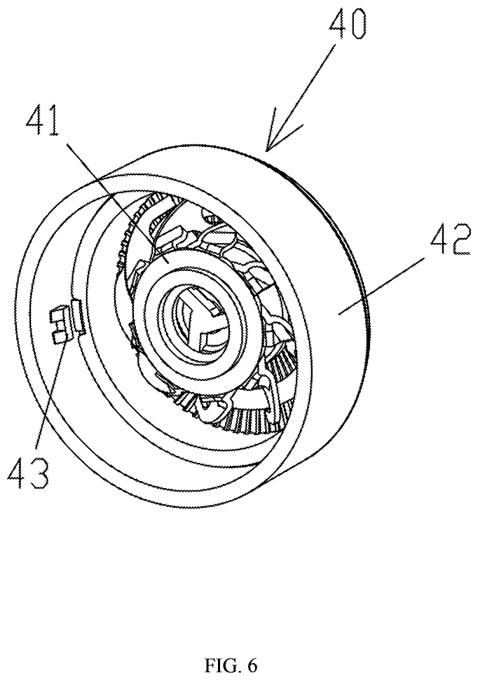

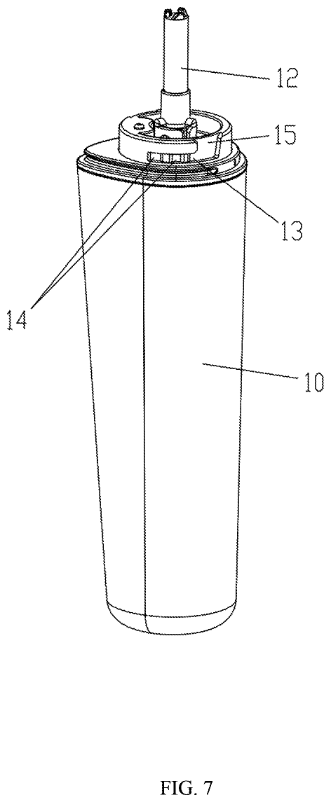

Referring to FIGS. 1 to 7, the present disclosure provides a hair remover, the hair remover includes a main body 10, a positioning member 20, a mounting member 30, and a blade assembly 40. The positioning member 20 is detachably mounted on the main body 10. One end of the mounting member 30 is detachably connected to the blade assembly 40, the other end of the mounting member 30 is received in the positioning member 20 and movably connected to the positioning member 20. The mounting member 30 defines a receiving chamber 31. At least one through hole 32 communicating with the receiving chamber 31 is defined on a periphery of the mounting member 30. The mounting member 30 is slidable to enable the positioning member 20 to completely cover the through hole 32.

In the present embodiment, three through holes 32 is provided, equidistantly arranged along the periphery of the mounting member 30 at a same height. The receiving chamber 31 is configured to collect body hair scraps caused by the blade assembly 40. The mounting member 30 is movably connected to the positioning member 20. The mounting member 30 is slidable and rotatable through the blade assembly 40. For example, the mounting member 30 is slidable in a direction away from the positioning member 20 for completely exposing the through holes 32, and the mounting member 30 is slidable in a direction close to the positioning member 20 for completely covering the through holes 32 with the positioning member 20. When it is required to remove the body hair scraps from the receiving chamber 31, the blade assembly 40 is slid to expose the through holes 32 completely. In this way, the receiving chamber 31 can be washed with water in any direction to ensure that the body hair scraps are completely removed from the receiving chamber 31, and the entire receiving chamber 31 can be seen by the user through the through holes 32.

In this embodiment, during removing of the body hair scraps from the receiving chamber 31, the blade assembly 40 is slid to completely expose the through hole 32, the hair remover is held slantly or horizontally, the body hair scraps accumulated in the receiving chamber 31 are first washed with water away from the receiving chamber 31 via the through holes 32. Then, the blade assembly 40 is washed with water to make the body hair scraps remaining in the blade assembly 40 to enter the receiving chamber 31 and finally be washed with water away from the receiving chamber 31 via the through hole 32.

Further, a tapered boss 33a protrudes from a bottom of the receiving chamber 31.

In this embodiment, during removing of the body hair scraps from the receiving chamber 31, the tapered boss 33 disperses the water flow so that the water sufficiently washes the inner wall of the receiving chamber 31, resulting in a better cleaning effect.

Further, the receiving chamber 31 is further provided with a stopper ring 34 fixedly connected to the mounting member 30. The main body 10 is provided with a motor (not shown), the motor is provided with a drive shaft 12 sequentially passing through the tapered boss 33 and the stopper ring 34 to connect with the blade assembly 40 in a transmission manner.

Further, the blade assembly 40 includes a cutter 41 and a cover 42. The cutter 41 is movably received in the cover 42 and abuts against the stopper ring 34. One end of the drive shaft 12 away from the motor is engaged with the cutter 41.

In this embodiment, the cutter 41 abuts against the stopper ring 34, by which the cutter 41 is limited within the cover 42. The end of the drive shaft 12 away from the motor is engaged with the cutter 41 to enable the motor to drive the cutter 41 to rotate through the drive shaft 12.

Further, a snap 43 is provided in the cover 42, a groove 35 is provided on the periphery of the mounting member 30, and the snap 43 is engaged with the groove 35.

In this embodiment, with engagement of the snap 43 with the groove 35, the blade assembly 40 and the mounting member 30 are detachably connected. The blade assembly 40 is detachable from the mounting member 30 manually, thereby facilitating replacement of the cutter 41 by a user.

Further, a first sliding slot 36 is provided on the periphery of the mounting member 30 and extends vertically, and both ends of the first sliding slot 36 are recessed inwardly to form a first limiting hole 37 and a second limiting hole 38, The positioning member 20 is provided with a first sliding block 21 movably received in the first sliding slot 36. The first sliding block 21 is slidable to engage with the first limiting hole 37 or the second limiting hole 38.

In this embodiment, when the first sliding block 21 is received in the first sliding slot 36, the mounting member 30 is driven to slide in a direction away from the positioning member 20 by pulling the blade assembly 40, or in a direction close to the positioning member 20 by pressing the blade assembly 40. The through holes 32 are completely covered by the positioning member 20 when the first sliding block 21 slides into engagement with the first limiting hole 37, or completely exposed when the first sliding block 21 slides into engagement with the second limiting hole 38 to uncover the through holes 32.

Further, a third limiting hole 39 is defined on the periphery of the mounting member 30 and communicates with the first limiting hole 37. A first limiting plate 391 is provided at a connection between the third limiting hole 39 and the first limiting hole 37. The first sliding block 21 is slidable to engage with the third limiting hole 39.

In this embodiment, the mounting member 30 is rotatable relative to the positioning member 20 with rotation of the blade assembly 40. After the first sliding block 21 slides into engagement with the first limiting hole 37, the blade assembly 40 is rotated clockwise to rotate the mounting member 30, so that the first sliding block 21 is slid over the first limiting plate 391 to engage with the third limiting hole 39. In this way, the mounting member 30 is prevented from sliding in a direction away from or near the positioning member 20.

Further, a second sliding slot 392 and a third sliding slot 393 are defined on the periphery of the mounting member 30. The second sliding slot 392 extends horizontally. The third sliding slot 393 extends to form a notch at an end of the mounting member 30. The third sliding slot 393 communicates with the second sliding slot 392, and the second sliding slot 392 communicates with the second limiting hole 38. A second limiting plate 394 is provided at a connection between the second sliding slot 392 and the second limiting hole 38.

In this embodiment, after the first sliding block 21 slides into engagement with the second limiting hole 38, the blade assembly 40 is rotated counterclockwise, the blade assembly 40 is rotated to rotate the mounting member 30, so that the first sliding block 21 slides over the second limiting plate 394 to enter the second sliding slot 392. The blade assembly 40 is further rotated counterclockwise to enable the first sliding block 21 to slide into contact with a side wall of the second sliding slot 392. Then, the blade assembly 40 is pulled to enable the mounting member 30 to slide away from the positioning member 20, so that the first sliding block 21 slides into the third sliding slot 393 and then exits the third sliding slot 393. In this way, the mounting member 30 is finally detached from the positioning member 20.

Further, a fourth sliding slot 13 is defined on a periphery of the main body 10 and extends horizontally. A second sliding block 22 is provided in the positioning member 20 and movably received in the fourth sliding slot 13. At least one fourth limiting hole 14 is formed in the fourth sliding slot 13, and the second sliding block 22 is slidable to engage with each fourth limiting hole 14.

Further, a fifth sliding slot 15 is defined on the periphery of the main body 10 and communicates with the fourth sliding slot 13. The fifth sliding slot 15 extends to form a notch at an end of the main body 10.

In this embodiment, two fourth limiting holes 14 are provided. When the second sliding block 22 slides into engagement with one of the fourth limiting holes 14, the positioning member 20 is prevented from sliding in a direction away from or close to the main body 10.

In this embodiment, when the second sliding block 22 slides to a connection between the fourth sliding slot 13 and the fifth sliding slot 15, the positioning member 20 is manually pulled to enable the second sliding block 22 to enter the fifth sliding slot 15 and then exit the fifth sliding slot 15. In this way, the positioning member 20 is finally detached from the main body 10.

It should be appreciated that the present disclosure may have various embodiments, and other embodiments obtained by those skilled in the art based on the embodiment in the present description without any creative effort fall within the protection scope of the present disclosure.

What is claimed is:

1. A hair remover comprising a main body, a positioning member, a mounting member and a blade assembly, wherein the positioning member is mounted on the main body, the mounting member has one end connected to the blade assembly and one other end received in the positioning member and movably connected thereto, the mounting member defines a receiving chamber, at least one through hole communicating with the receiving chamber is defined on a periphery of the mounting member, and the mounting member is slidable to enable the positioning member to completely cover the through hole.

2. The hair remover according to claim 1, wherein a tapered boss protrudes from a bottom of the receiving chamber.

3. The hair remover according to claim 2, wherein the receiving chamber is further provided with a stopper ring fixedly connected to the mounting member, the main body is provided with a motor with a drive shaft, the drive shaft sequentially passes through the tapered boss and the stopper ring to connect with the blade assembly in a transmission manner.

4. The hair remover according to claim 3, wherein the blade assembly comprises a cutter and a cover, the cutter is movably received in the cover and abuts against the stop ring, and one end of the drive shaft away from the motor is engaged with the cutter.

5. The hair remover according to claim 4, wherein a snap is provided in the cover, a groove is provided on the periphery of the mounting member, and the snap is engaged with the groove.

6. The hair remover according to claim 1, wherein a first sliding slot is provided on the periphery of the mounting member and extends vertically, both ends of the first sliding slot are recessed inwardly to form a first limiting hole and a second limiting hole, the positioning member is provided with a first sliding block movably received in the first sliding slot, and the first sliding block is slidable to engage with the first limiting hole or the second limiting hole.

7. The hair remover according to claim 6, wherein a third limiting hole is defined on the periphery of the mounting member and communicates with the first limiting hole, a first limiting plate is provided at a connection between the third limiting hole and the first limiting hole, and the first sliding block is slidable to engage with the third limiting hole.

8. The hair remover according to claim 6, wherein a second sliding slot and a third sliding slot are defined on the periphery of the mounting member, the second sliding slot extends horizontally, the third sliding slot extends to form a notch at an end of the mounting member, the third sliding slot communicates with the second sliding slot, the second sliding slot communicates with the second limiting hole, and a second limiting plate is provided at a connection between the second sliding slot and the second limiting hole.

9. The hair remover according to claim 1, wherein a fourth sliding slot is defined on a periphery of the main body and extends horizontally, a second sliding block is provided in the positioning member and movably received in the fourth sliding slot, at least one fourth limiting hole is formed in the fourth sliding slot, and the second sliding block slidable to engage with each of the at least one fourth limiting hole.

10. The hair remover according to claim 9, wherein a fifth sliding slot is defined on the periphery of the main body and communicates with the fourth sliding slot, and the fifth sliding slot extends to form a notch at an end of the main body.
